(19) United States
(12) Patent Application Publication
(10) Pub. No.: US 2004/0202531 A1
(43) Pub. Date: Oct. 14, 2004

(54) System for handling material and parts cut therefrom

(75) Inventors: Michael Beransky, Irvine, CA (US); Roberto J. Tsai, Arcadia, CA (US); Joseph R. Greeninger, Irvine, CA (US)

Correspondence Address: Irving Keschner, Suite 1150, 21515 Hawthorne Boulevard, Torrance, CA, 90503, US

(73) Assignee: AMADA AMERICA INC.

(21) Appl. No.: 10/352,276

(22) Filed: Jan. 29, 2003

(51) Int. Cl. B65G 1/10

(52) U.S. Cl. 414/331.18; 414/751.1; 414/752.1

(57) ABSTRACT

An automated system for handling material and parts cut therefrom. The system includes means for unloading a material pallet positioned on a shelf within a first storage device and loading the material on a movable cart, transporting the material to an unloading station wherein the material is positioned onto a first shuttle table, the shuttle moving to a laser cutting station, unloading the cut material from the cutting station after parts are cut in the material, and transporting the cut parts on a pallet to a selected shelf in a second storage device using movable carts. The skeleton material remaining after the cutting operation is collected for eventual disposal. A second shuttle table is used to prepare additional material for cutting after the material brought by the first shuttle table is moved to the laser cutting station. A frame member, having forks, clamps and suction cups, is provided, inter alia, to pick up the material containing the cut parts and unloading the parts into movable cart for delivery to the second storage device.

### BACKGROUND OF THE INVENTION

1. Field of the Invention

The present invention provides a system for storing material, transporting the material to a cutting station forming parts in the material, separating the parts from the material, transporting the parts to a storage area and disposing of the remainder skeleton.

2. Description of the Prior Art

When forming sheet metal products, one or more parts are formed in a piece of sheet metal and are connected to the sheet metal through one or more micro-joints. In order to separate these parts, it is conventional that subsequent mechanical or manual hammering or vibrating must be carried out with respect to the sheet metal. In addition to potential damage such as cuts, bends, and depressions formed on the part, the conventional parts separation process is noisy and labor intensive, increasing the overall costs of fabricating sheet metal parts.

U.S. Pat. No. 5,284,043 to Hayashi describes a process for separating a part from a sheet of metal. In order to separate the part from the sheet while avoiding damage to the part, the sheet metal and the part contained therein must be specially prepared. In particular, the part must be first contoured while leaving a small joint such as a connecting web or micro-joint which connects the part of the sheet metal, and thereafter, a protrusion must be formed on or adjacent to the joint by lancing, embossing, or semi-shearing, the sheet metal then being transported to the pressing operation to press the protrusion in order to shear the micro-joint. The necessity of specially preparing the sheet metal and the part contained therein requires specially designed machinery to perform that task. This increases the overall production cost of each formed part. The parts separation process described in the background of the Hayashi patent is typical of that utilized in the sheet metal industry.

Other industries have utilized different techniques for separating a component joined to a carrier sheet. For example, U.S. Pat. No. 4,467,948 to Deslauriers discloses a machine for stripping waste form previously die-cut blanks; U.S. Pat. Nos. 4,033,240 and 4,467,940 to Desllauriers disclose a device for automatically removing waste material from die-cut blanks; U.S. Pat. No. 3,391,589 to Bishop also discloses an apparatus for cutting blanks from board and separating the scrap from the blanks; U.S. Pat. No. 4,561,334 to Sarka discloses a rotary cutting device that cut blanks from thin sheets of webs of material such as paper, paper board, cardboard, plastic film, metal foil, sheet metal and the like; and U.S. Pat. No. 4,109,842 to Acquilla discloses a device for automatically stripping waste material from sheeting such as precut cardboard, the device incorporating projections which interact with the waste portion of the sheeting enabling its removal.

Other than the Hayashi patent, the other prior art references noted above all deal with separating products from a sheet carrier, the carrier comprising material other than sheet metal.

Due to the nature of the sheet metal working process, separating devices which can be utilized in other industries, such as cartons, paper, etc., cannot be efficiently and effectively utilized. As noted in the Hayashi patent, the separation process is typically carried out by manual means, i.e. after the micro-joints are formed, sheets are typically delivered to an area where workers either shake the sheet to cause the micro-joints to sever or use hammers of other mechanical components to do the separation.

U.S. Pat. No. 5,913,468 to Tsai et al, assigned to an affiliate of the assignee of the present invention, discloses an apparatus for separating parts from the sheet metal carrier. In particular, a single carrier sheet from a stack of sheets having parts micro-joined to the carrier sheet is transported to the nip between upper and lower main pinch rollers. The main rollers then move to transport the sheet to a separation device on the opposite side of the main rollers. The main rollers drive the sheet material in a manner such that the top surface of the leading edge of the sheet metal is engaged below the forward tip of the separation device. The separation device is then moved downwardly so that the upper surface of the separation device assembly is level to the part pass line, the downward motion of the separating device breaking the micro-joints thus freeing the parts as they contact the edge of the separating device. The main rollers continue to feed the sheet metal such that the remainder scrap, or skeleton, portion is driven in a downward direction and the parts separated by the process are transported in the forward direction where they are collected. The upper roller is moved vertically in an oscillatory manner to relieve the stress in the sheet material. The skeleton is formed into a coil, the coiled skeleton thereafter being flattened for scrap and transportability purposes.

Although the apparatus disclosed in the '468 patent eliminates the labor intensive techniques currently utilized in the sheet metal industry, it is not readily adaptable for use in high speed systems wherein the steps of transporting material to a cutting device from a storage area, separating the parts from the material, transporting the separated parts and skeleton to another storage area and transporting the skeleton to a disposal area are required.

### SUMMARY OF THE INVENTION

The present invention provides an automated system for handling material and parts cut therefrom. The system includes means for unloading a pallet having material thereon from a first storage device and loading the material pallet to a movable cart, transporting the material pallet to an unloading station wherein the material is removed by a frame device having suction cups and forks thereon and positioned onto a shuttle table which moves the material into a laser cutting station, removing the cut material from the laser cutting station, unloading the cut material from the cutting station, and transporting the cut parts to a second storage device using movable carts. The remaining material, or skeleton, is collected for eventual disposal.

A second cart on the shuttle table is used to prepare additional material for cutting after the material brought by the first shuttle cart is moved to the laser cutting station. The frame device picks up the pallets containing the parts and unloads the parts in the second storage system.

The present invention thus provides a modular laser parts cutting system wherein the entire process including loading/unloading the material and moving/unloading the cut parts, is highly automated, and provides a rapid and efficient system for separating parts from the material skeleton.

The loading and unloading portions of the cutting system is adaptable for use with existing cutting systems which currently utilize manual loading and unloading systems.

### DESCRIPTION OF THE DRAWING

For a better understanding of the present invention as well as other objects and further features thereof, reference is made to the following description which is to be read in conjunction with the accompanying drawing therein:

FIG. 1 is a perspective view of the laser cutter and shuttle portions of the system of the present invention;

FIG. 2 is an enlarged end view of the laser cutter and shuttle portions shown in FIG. 1;

FIG. 3 is a cross-sectional view along lines 3-3 of FIG. 1;

FIG. 4 is a side view of the system components shown in FIG. 1;

FIG. 5 is a side view of the system components shown in FIG. 1 showing the upper shuttle in the process of being loaded with material;

FIG. 6 is a side view showing the upper shuttle in position under the laser cutter;

FIG. 7 is a side view illustrating completion of the material laser cutting on the upper shuttle;

FIG. 8 shows the upper shuttle moved from the laser cutter;

FIG. 9 shows the lower shuttle moved upwards to engage the laser cutter track;

FIG. 10 shows the lower shuttle in place under the laser cutter and material being cut while the cut material on the upper shuttle is unloaded;

FIG. 11 shows the upper shuttle cart being reloaded with material;

FIG. 12 shows the lower shuttle cart removed from the laser cutter station and the upper shuttle cart reloaded;

FIG. 13 shows the upper shuttle cart lowered in position to be returned to the laser cutter station;

FIG. 14 shows the upper shuttle cart with new material moved into the laser cutter station while cut material on the lower shuttle cart is unloaded;

FIG. 15 shows the material on the upper shuttle cart being cut and the lower shuttle cart being reloaded with material;

FIG. 16 is a top plan view of the laser cutter station, shuttle table and loading arm;

FIG. 17 is a view along line 17-17 of FIG. 16;

FIG. 18 is a view along line 18-18 of FIG. 16;

FIG. 19 is a top plan view of a second embodiment of a material loading device used in the present invention;

FIG. 20 is an enlarged end view of the device shown in FIG. 19;

FIG. 21 is a cross-sectional view along line 21-21 of FIG. 20;

FIG. 22 is similar to FIG. 19 but illustrates the separate shuttle table and multiple storage towers;

FIG. 23 is a view along line 23-23 of FIG. 22;

FIG. 24 is a view along line 24-24 of FIG. 23;

FIG. 25 shows the system frame member with the pallet forks system;

FIG. 26 illustrate the fork system picking up the upper cut part pallet;

FIG. 27 illustrate the forks in the open position with the upper pallet unloaded;

FIG. 28 illustrate the lower shuttle cart moved up into position for the cut part pallet to be unloaded;

FIG. 29 illustrate in more detail the fork system engaging the parts pallet;

FIG. 30 illustrate the clamp portion of the frame member engaging and picking up the cut material;

FIG. 31 is a bottom view of the frame member material clamp and suction cups;

FIG. 32 is a top plan view of the material table;

FIG. 33 is a side view of the material table;

FIG. 34 is an end view of the material loading table; and

FIG. 35 is a cross-sectional view along line 35-35 of FIG. 34.

### DESCRIPTION OF THE INVENTION

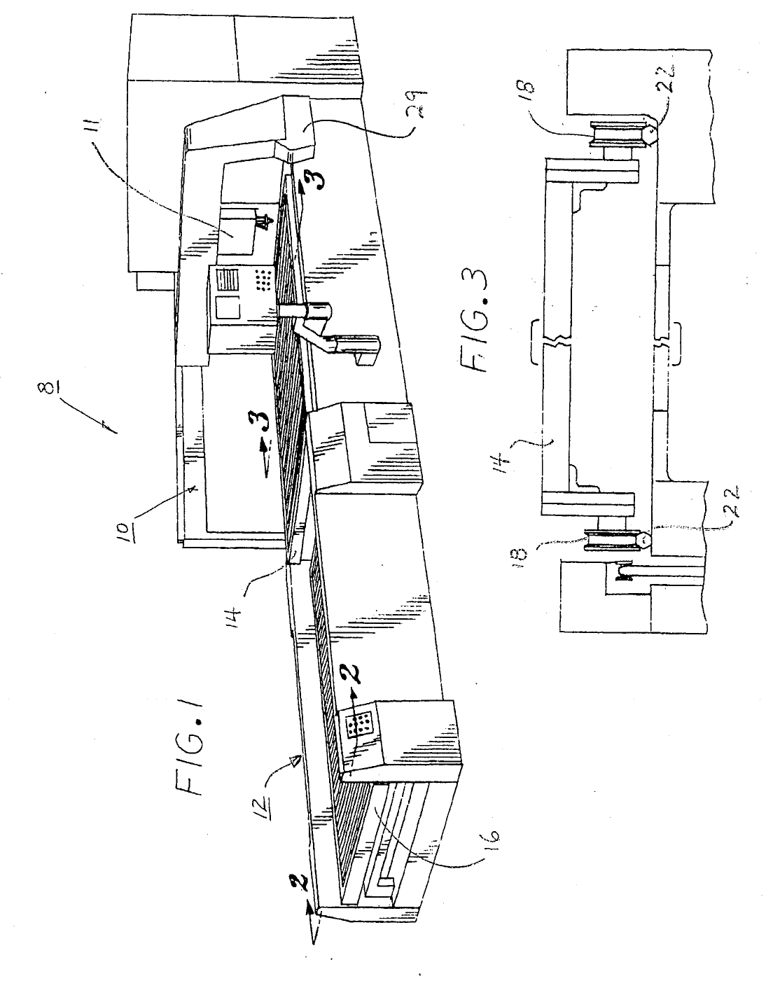

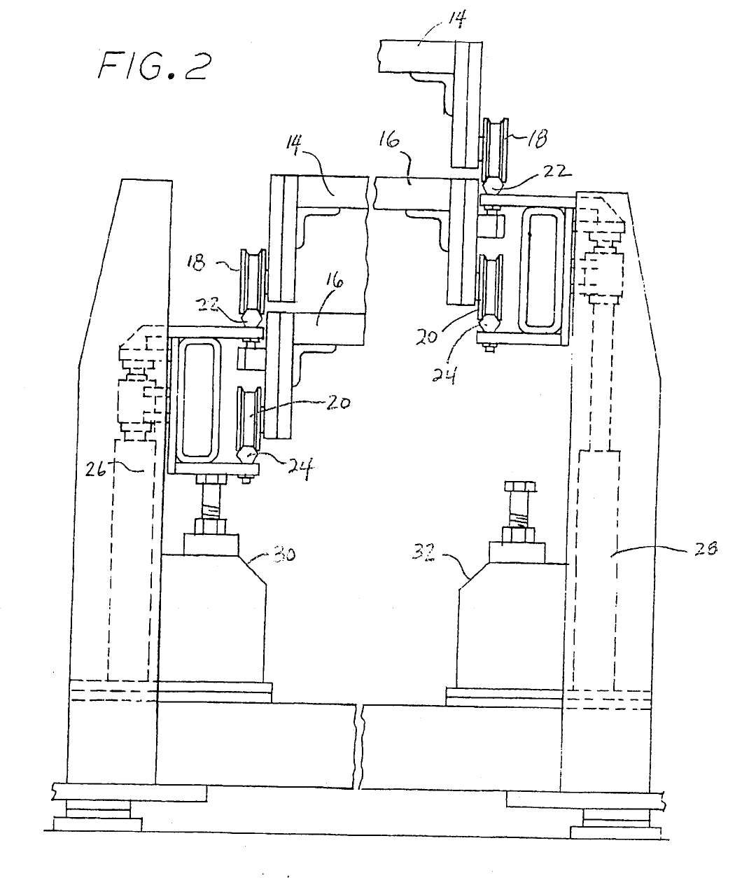

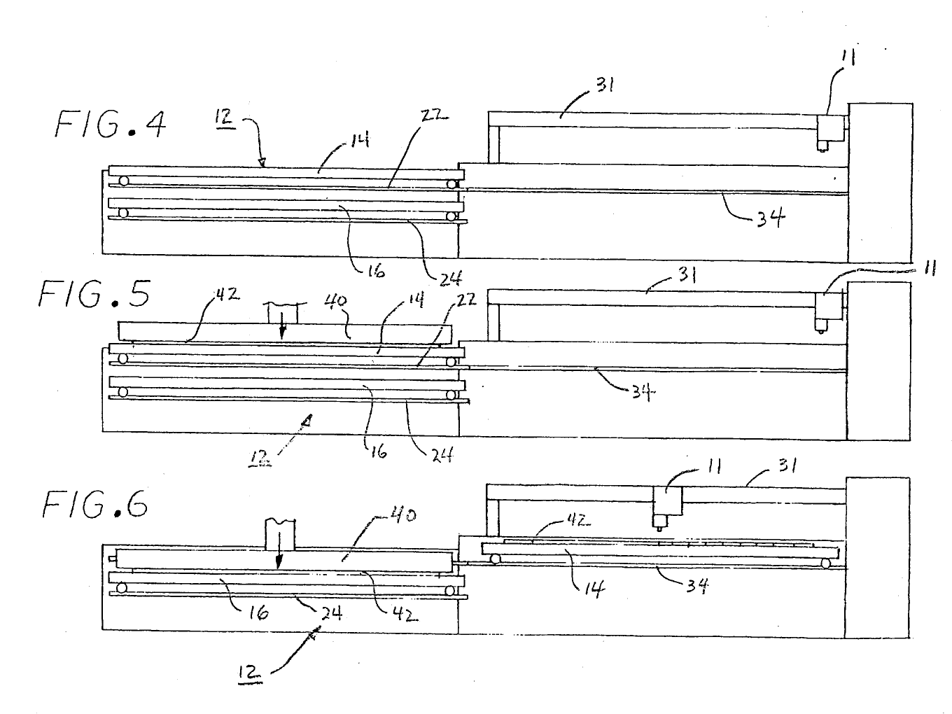

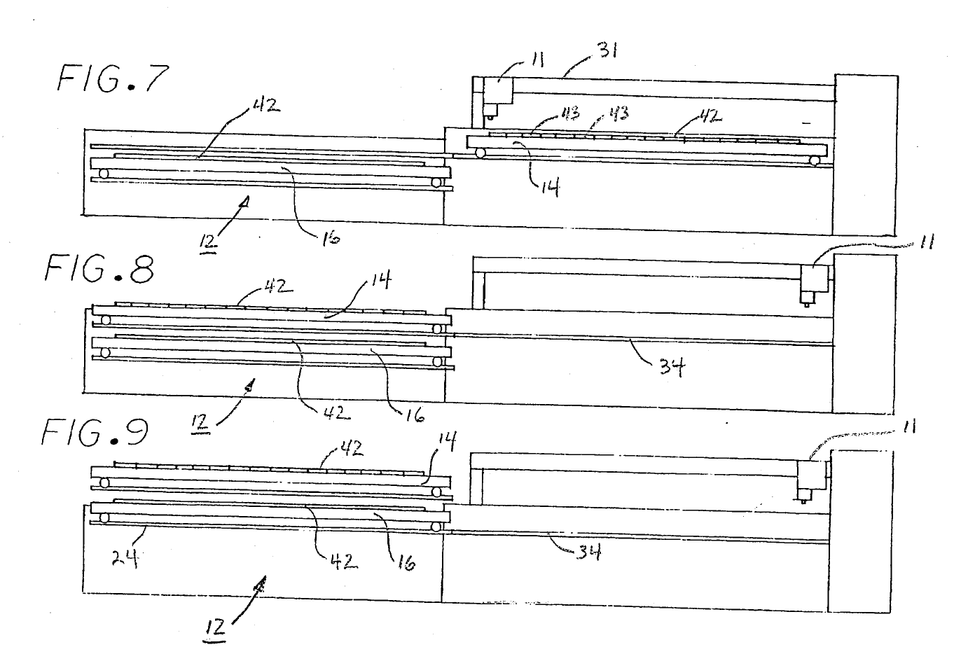

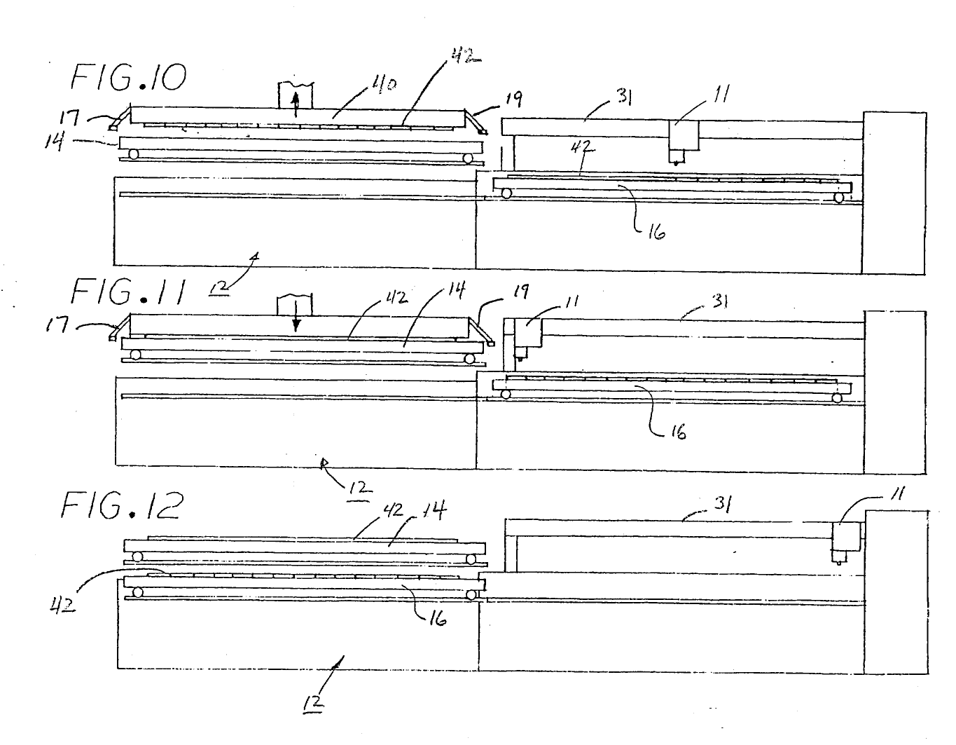

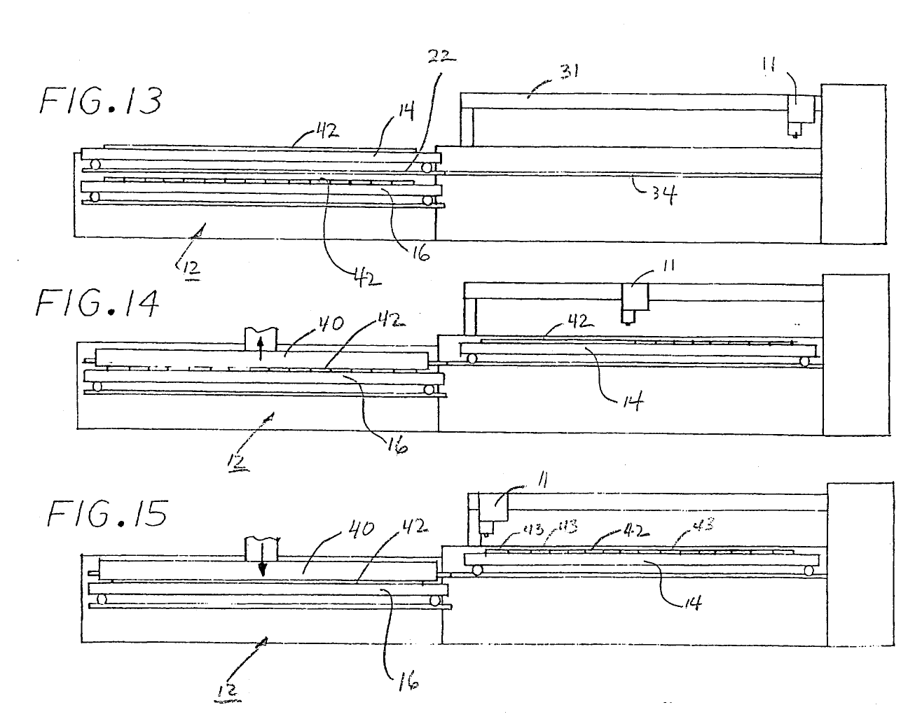

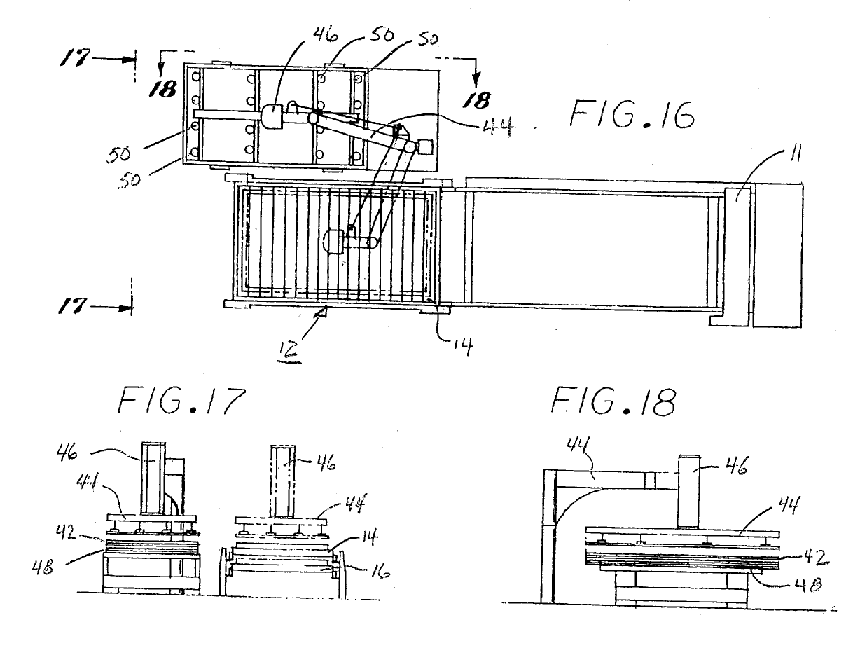

Referring now to FIGS. 1-3, a portion of the automated system for handling material and parts cut therefrom of the present invention is illustrated. System 8 comprises a laser cutting device 11, shuttle table 12, upper shuttle cart 14, lower shuttle cart 16, cart wheels 18 and 20, tracks 22 and 24, and cylinders 26 and 28. Cylinders 26 and 28 operate to raise and lower shuttle carts 14 and 16 in a predetermined sequence such that the carts can be aligned with the tracks associated with laser cutting device 11.

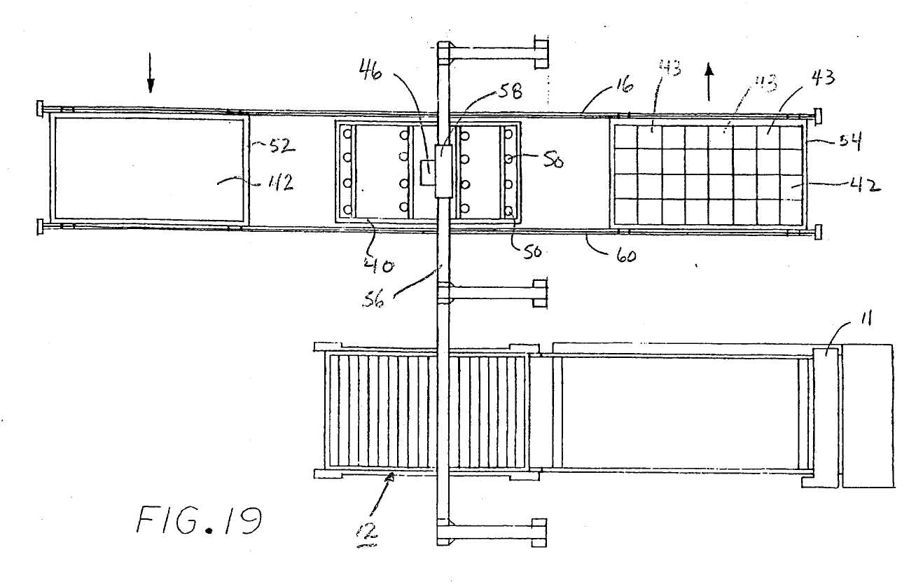

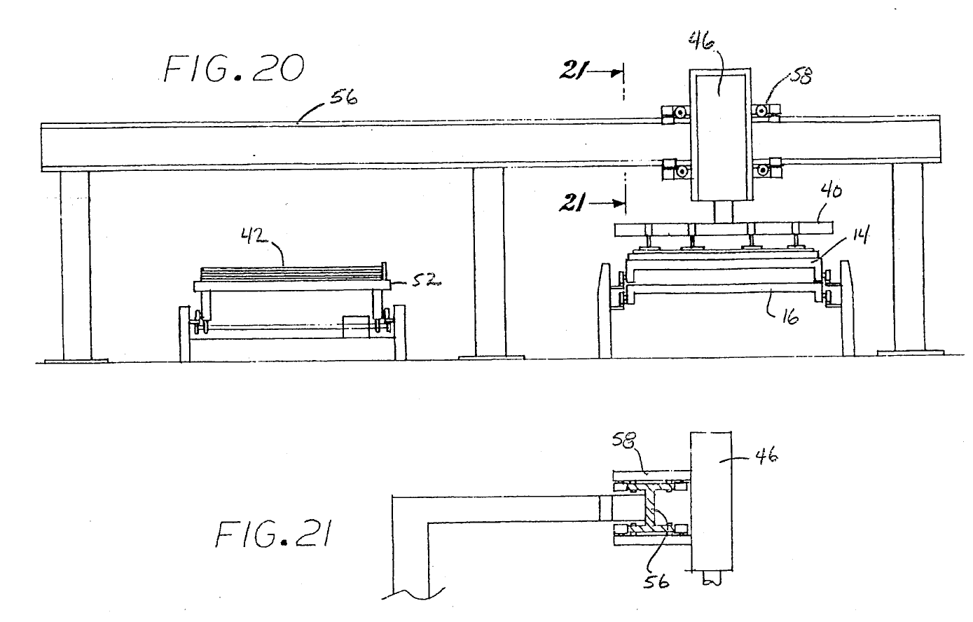

FIG. 2 is an enlarged end view of system 8 showing upper shuttle cart 14 and lower shuttle cart 16. The left side of the FIG. 2 shows shuttle carts 14 and 16 in the lower position, the right side showing shuttle carts 14 and 16 in the upper position. Upper shuttle cart 14 rides on four wheels 18 (only two illustrated) and lower cart 16 rides on wheels 20 (only two illustrated). Wheels 18 and 20 in turn ride on tracks 22 and 24, respectively. Cylinders 26 and 28 move shuttle carts 14 and 16 to their up and down positions, respectively. When the shuttle cart 16 is in the down position, it rests on adjustable stops 30 and 32. FIG. 3 is a cross-sectional view showing upper shuttle cart 14 moved into position in laser cutting device 11. Laser cutting device 11 incorporates a set of tracks 34 that align with tracks 22 and 24 of shuttle carts 14 and 16, respectively, when the carts are in position to deliver raw material to the laser cutting unit 11. Laser unit 11 is mounted in carriage 29 which is movable along rail 31.

FIGS. 4-15 illustrate the operation of system 8 regarding the direct loading/unloading of material on/off shuttle table 12 (it first should be noted that the same reference numeral in each application figure identifies identical components). In particular, FIG. 4 shows shuttle carts 14 and 16 prior to initiation of the cutting operation and positioned at the material loading and parts unloading station. Track 22 is illustrated as being in alignment with track 34 associated with laser cutting device 1I. FIG. 5 shows the upper shuttle cart 14 being loaded with material 42 using frame member 40. In particular, frame member 40 includes a plurality of suction cups as will be described hereinafter in more detail and which pick up the material 42 from a material cart and loads it on shuttle cart 14. FIG. 6 shows upper shuttle cart 14 in place under laser unit 11; as material 42 is being cut by laser unit 11 and unit moves along channel 31, the lower shuttle cart 16 is loaded with additional material 42 by frame member 40 in a process identical to that utilized to load shuttle cart 14.

FIG. 7 shows material 42 having parts 43 cut therein by laser unit 11, laser unit 11 have traversed channel 31 to complete the cutting of parts 43 in material 42. FIG. 8 shows shuttle cart 14 moved back to the loading and unloading station with the cut material 42 thereon. At the same time, laser unit 11 has returned to its start position. FIG. 9 shows the upper and lower shuttle carts 14 and 16, moved upwardly by cylinders 26 and 28, enabling track 24 of shuttle cart 16 to move into alignment with laser track 34.

FIG. 10 illustrates shuttle cart 16 moved into place under laser unit 11 and the additional material 42 thereon in the process of being cut while cut material 42 on shuttle cart 14 is unloaded by a system of fork members contained on frame member 40. As will be set forth hereinafter in more detail hereinafter, the frame member 40 also contains a series of clamp members which hold the cut material 42 after the fork members are in the open position. The cut parts are then separated from the remaining material, or skeleton, by gravity (or by a shaking movement) and the parts deposited on a pallet positioned on a parts cart. A plurality of sensors (only two sensors 17 and 19 are illustrated) can be provided on frame member 40 to ensure that the level of the stored cut parts on the parts pallet are within a predetermined range before being transported to a parts storage tower.

FIG. 11 illustrates the next step in the process after the cuts in material 42 on table cart 16 has been completed. In particular, frame member 40 loads new material on shuttle cart 14.

FIG. 12 illustrates the next step in the process wherein shuttle cart 16 is returned to the initial loading position with its cut parts thereon and shuttle cart 14 having been reloaded with new, uncut material 42.

FIG. 13 illustrates shuttle carts 14 and 16 being moved downwardly by cylinders 26 and 28, tracks 22 below shuttle cart 14 being aligned with laser tracks 34 in a manner such that material 42 will be positioned under laser unit 11 in the next step of the process.

FIG. 14 illustrates shuttle cart 14 with new material 42 thereon moved into the cutting station under laser unit 11 and being cut as the cut material on shuttle cart 16 is unloaded by the fork members on frame member 40.

FIG. 15 illustrates the material 42 on shuttle cart 14 having been cut into parts 43 and shuttle cart 16 being reloaded with new material 42 by frame member 40.

The loading/unloading of shuttle carts 14 and 16 as described hereinabove are then repeated as often as necessary.

A computer system is utilized to control the loading and unloading of material 42 or carts 14 and 16, the movement of the carts into and out of the cutting station and the operation of laser unit 11. Although the computer system is necessary to control the overall operation of the automated material handling system, the specific computer (microcontroller and software utilized) is not considered a part of the present invention and the details thereof have not been set forth.

FIGS. 16-18 illustrates frame member, or material loader plate, 40 in more detail, frame member 40 unloading material from the material cart 42 onto shuttle table 12 prior to delivery to laser unit 11. Frame member 40 incorporates a loading arm 44 and a plurality of pickup members, such as suction cups, 50 mounted thereon. The position of material head 46 is controlled by the computer and driven by a cylinder (not shown) and unloads material 42 from the material cart 48 and delivers the material to the shuttle carts 14 and 16. The left hand portion of FIG. 17 illustrates frame member 40 removing material 42 from material cart 48 and the right hand portion of the figure illustrates material 42 loaded on shuttle carts 14 and 16. In the first embodiment of the invention as described hereinabove with reference to FIGS. 1-18, the unloading of the cut material after the cutting operation is completed is performed manually.

FIGS. 19-35 illustrate a second embodiment of the present invention. In particular, material cart 52 is illustrated in position to have material 42 unloaded therefrom and parts cart 54 in position to receive material 42 cut into parts 43. The loading head 46 is mounted to a trolley cart 58 and moves along rail 56. The material cart 52, after being loaded with material 42, moves to a position whereby the frame member 40 can, via suction cups 50, pick up the top sheet of material 42 by moving along rails 60 and then transporting the material, via material loader head 46 and trolley cart 58 along head rail 56 to shuttle table 12. The parts 43 are removed from the cut material as will be described hereinafter and the cut parts transferred to the finished cut parts cart 54 using frame member 40 by reversing the movement along head rail 56 and rails 60.

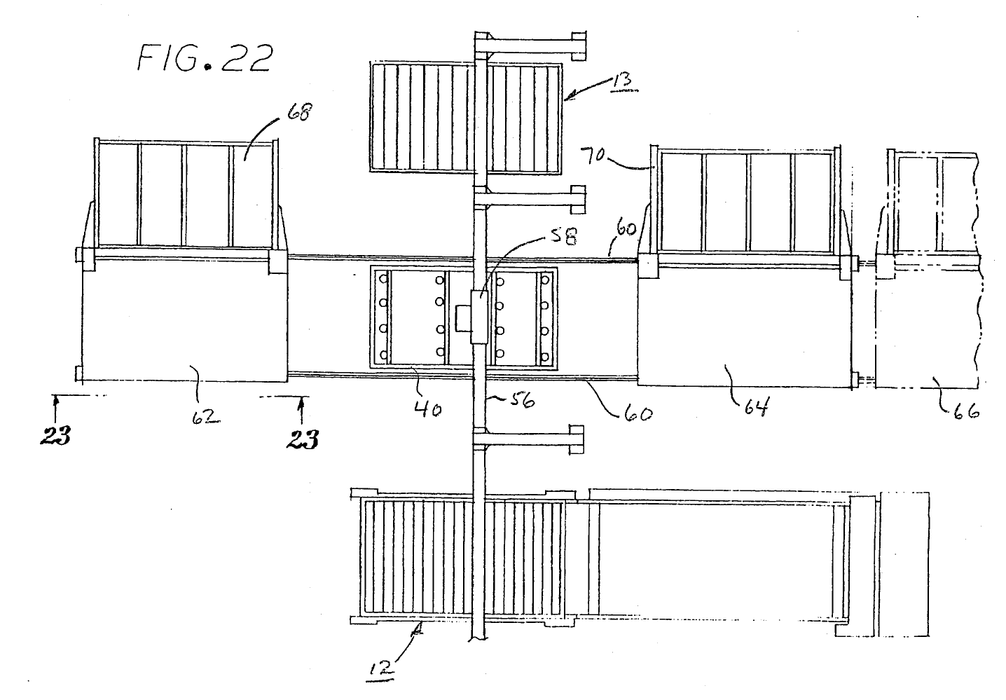

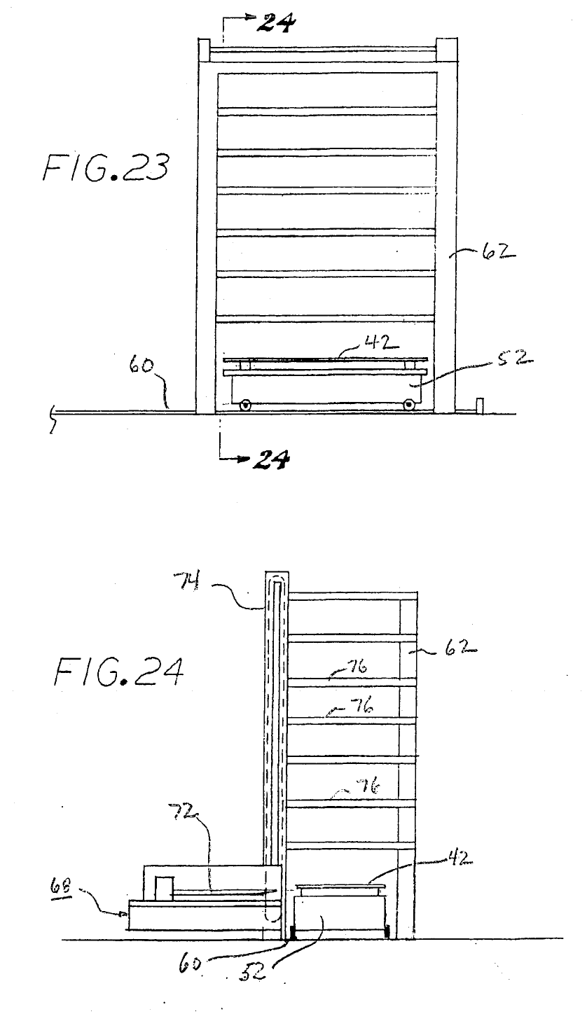

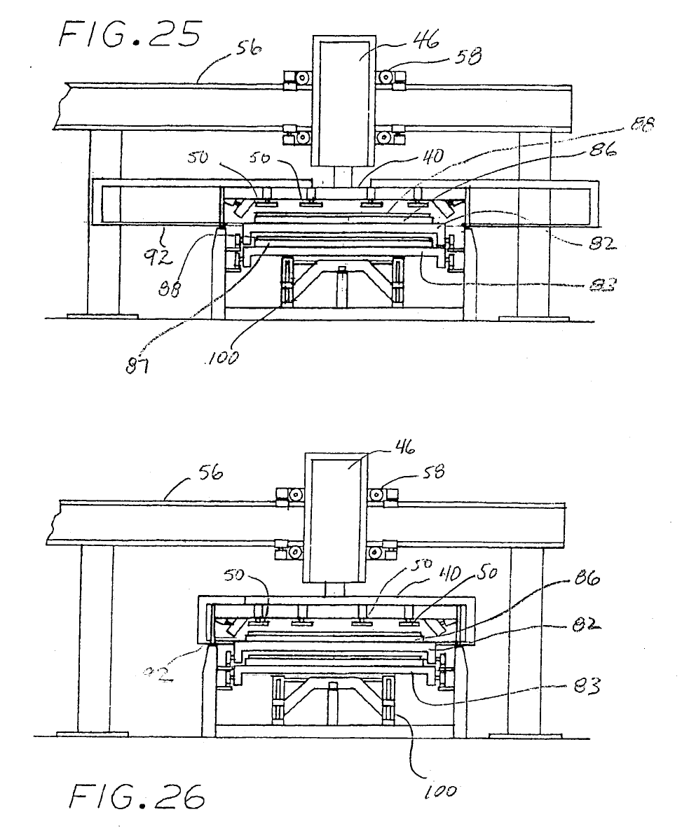

FIGS. 22 and 23 illustrate how the material cart 52 transports material using rails 60 from storage tower 62 to shuttle table 12. In particular, elevator 68 moves a selected material pallet into position whereby a fork system 92 (see FIGS. 25 et seq.) lifts the pallet onto the material cart 42. The material cart then moves along rails 60 into position as shown in FIG. 22 wherein frame drive 40 is in position to pick up material 42 as set forth hereinabove. In a similar manner, cut material 42 is moved from shuttle table 12 by frame device 40, returned along rail 56 to a pallet on a parts cart 54 positioned on rails 60 and then moved to parts tower 64. Elevator 70 then lifts the parts pallet to a selected shelf within the tower 70. Note that additional storage towers can be provided if necessary, such as tower 66 illustrated in phantom. In addition, a second shuttle table 13 and cutting station (not shown) can be provided to increase the through put of the processing system disclosed.

FIG. 24 shows elevator 68 in more detail, illustrating pickup forks 72 formed thereon. Forks 72 move in, pick up the selected material pallet, and then move back out. Elevator 68 is driven vertically by chain drive 74, material 42 being stored on a pallet on one of a plurality of shelves 76.

FIG. 25 illustrates the operation of frame device 40 in more detail as the material removed from the material carts and loaded onto shuttle 12. In particular, a first lifting table 82 supports a first pallet 86 having material (or parts) 88 thereon and a second lifting table 83 supports a second pallet 87 having material (or parts) 88 thereon. As elevator 100 is provided to move the pallets 86 and 87, in sequence, into position for capture by forks 92. It should be noted that frame device 40 function to both unload/load material/parts at the storage towers and also to load material at shuttle table 12 and to remove the cut parts therefrom.

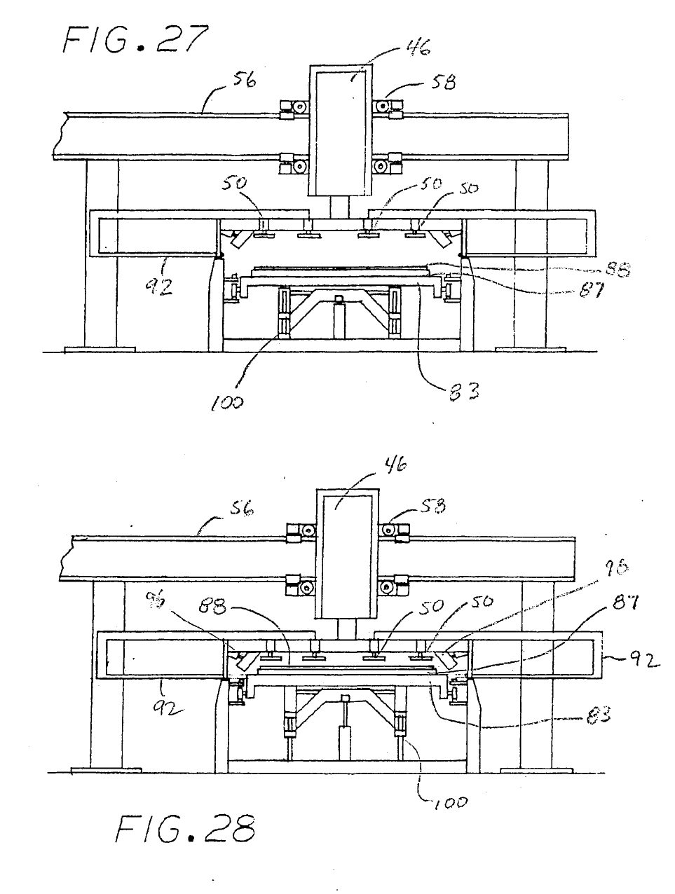

FIG. 26 illustrates forks 92 in position and in contact with the bottom surface of pallet 86. As described hereinabove, frame device 40 then transports the material (or parts) containing pallet to the shuttle table 12. FIG. 27 illustrates forks 92 in the retracted, or open, position and table 82 missing as frame device 40 returns to the load/unloading station after transporting pallet 86 to shuttle table 12. The first lifting table 82 (and the second lifting table 84) raises the pallets via elevator 100 to a loading/unloading level at the same height each time.

FIG. 28 illustrates second lifting table 83 being moved into position using elevator 100, enabling pallet 87 to be removed by forks 92.

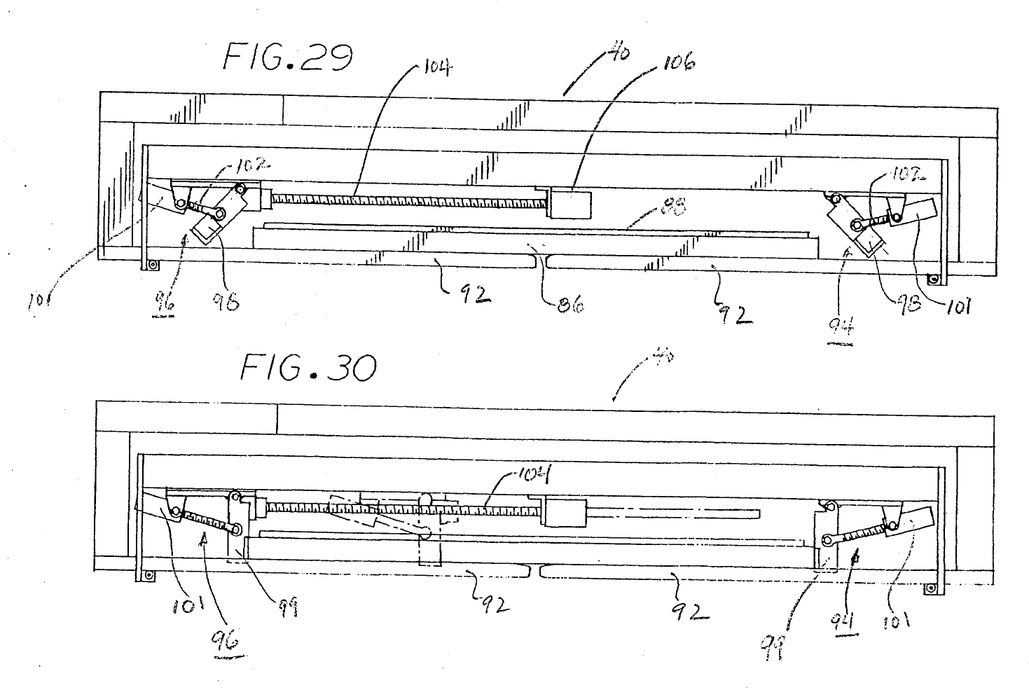

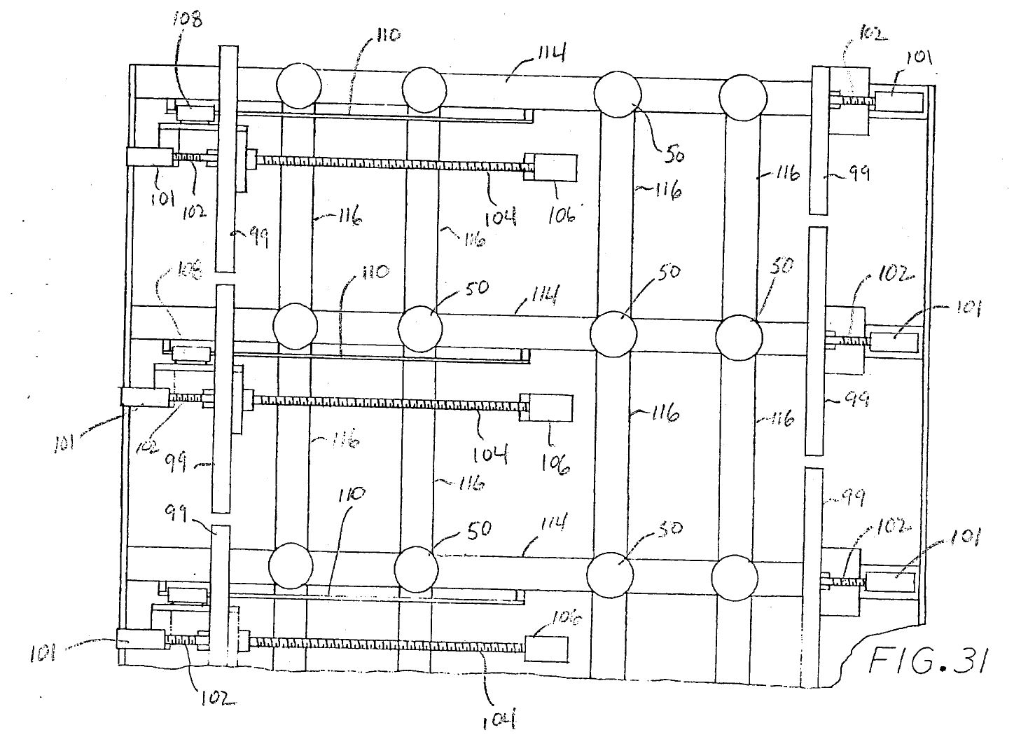

FIGS. 29 and 30 show in more detail how the forks/clamp components of frame device 40 operate to remove and hold the pallets in position after removal from the tables 82 and 84. FIG. 29 shows the forks 92 (forks 92 actually comprise a plurality of finger-like protrusions along the longitudinal extent of frame device 40). As noted hereinabove, the forks are automatically activated when the elevator 100 has properly positioned the pallets. Illustrated in the figure is fixed clamp 94, movable clamp 96, clamp blocks 99, clamp motors 101, clamp motor screw shaft 102, movable clamp screw 104, movable clamp motor 106.

FIG. 29 illustrates the situation when the forks 92 are initially positioned to engage the material/parts pallet 86. FIG. 30 illustrates the situation when the fixed clamp 94 and adjustable clamp 96 are locked into position to hold the pallet 86 in place against clamp blocks 99 when the clamp motors 101 are energized. Clamp 96 is adjustable along clamp screw 104 in order to accommodate various sized pallets (an adjusted position of movable clamp 96 is illustrated in phantom).

FIG. 31 is a bottom view of the frame device 40 with forks 29 retracted. In particular, FIG. 31 illustrates clamp blocks 99, clamp motor 101, clamp motor screw shafts 102, movable clamp screws 104, movable clamp motors 106, movable clamp bearings 108 and movable clamp guide rods 110. A plurality of suction cups 150 are mounted to horizontal and vertical frame members 114 and 116, respectively, as illustrated.

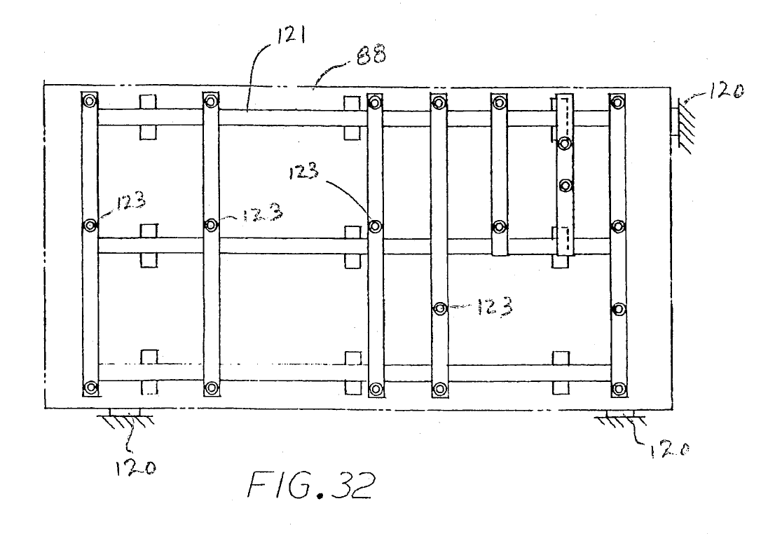

FIG. 32 is a plan view of material table 12 (14) with material 88 positioned thereon. The material table includes material stops 120, post frame 121 and posts 123. Posts 123 are provided to support and properly orientate material 88. As set forth hereinabove, the forks 92 engage the bottom surface of the pallets when energized.

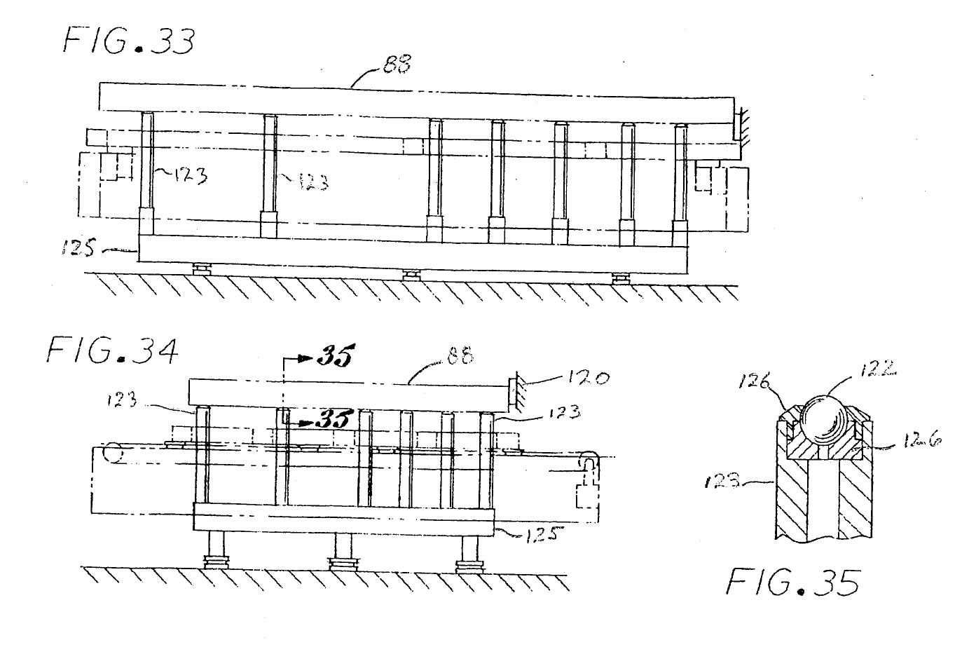

FIG. 33 is a side view of the material table 82 (and 84) showing material 88 supported on posts 123, posts 123 supported on post frame 125; FIG. 34 is an end view of material tables 14 (and 16); and FIG. 35 is a sectional view illustrating ball 122 supported on the top of posts 123, bearing or ball seat, 126 and keeper 126 designed to maintain the ball in position such that only a portion of the ball surface interacts with material 88. Balls 122 enable the material stack to slide into position along the top portion of posts 123.

In summary, with respect to the material unloading stage, the lifter forks remove the material containing pallet from the material storage tower and places the pallet on a material cart. The material cart is a self-propelled unit and is automatically directed to the frame member 40 and positioned therein by electrical sensors. The frame member 40, driven by a servo motor, stops in a position which is in alignment with the material cart in a manner such that the suction cups can remove the material, transport the material to the shuttle carts 12 and 14 and then release the suction pressure whereby the material is placed on the shuttle carts. The frame member 40 can move forward, backwards, and up and down in the vertical direction.

With respect to the parts unloading stage, the forks on frame member 40 move the cut material from the shuttle carts to a parts pallet. The parts pallet is then placed on a self-propelled, movable cart and the movable and fixed clamps energized; the clamps function to hold the material skeleton after the forks are retracted, enabling the parts to drop onto the pallet on the parts cart. After the parts drop, the clamps open and the skeleton can be dropped into the parts cart or moved to a separate location and the skeleton dropped thereat. The separate movable parts cart moves to the storage tower and the pallet is then positioned on a particular shelf by the lifter device.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A material handling system comprising:
means for transporting a first material member from a first storage member having a plurality of storage shelves to a material conveying station;
means for loading said first material member on said conveying station at a first location;
a material cutting station spaced from said first location and adapted to receive said first material member;
means for activating said material cutting station whereby parts are cut in said first material member; said cut first material member being conveyed back to said first location;
means for engaging said cut first material wherein said cut parts are separated from said first material member and are placed on a receiving member; and
means for directing said receiving member to a second storage member having a plurality of storage shelves.

2. The system as set forth in claim 1 wherein a second material member is transported from said first storage member to said material conveying station.

3. The system as set forth in claim 2 wherein said second material member is loaded on said conveying station at said first location after said cut first material member is engaged.

4. The system as defined in claim 3 wherein said engaging means comprises a frame member having suction cups and clamp members formed thereon.

5. The system as defined in claim 4 wherein said engaging means further comprises fork means formed thereon.

6. The system of claim 1 wherein said first material member is on a pallet positioned on a selected shelf in said first storage member.

7. The system of claim 6 wherein said cut parts are stored on a pallet positioned on a selected shelf in said second storage member.
